(19) United States
(12) Patent Application Publication
(10) Pub. No.: US 2005/0261922 A1
(43) Pub. Date: Nov. 24, 2005

(54) Authoring and distributing research analysts' initial reactions to breaking information

(76) Inventors: Mary Jane Marchisotto, New York, NY (US); Charles Chasin, Larchmont, NY (US); Ryan Joseph Marshall, New York, NY (US)

Correspondence Address: KIRKPATRICK & LOCKHART NICHOLSON GRAHAM LLP, 535 SMITHFIELD STREET, PITTSBURGH, PA, 15222, US

(21) Appl. No.: 10/850,493

(22) Filed: May 20, 2004

(51) Int. Cl. G06F 17/60

(52) U.S. Cl. 705/1; 705/26; 705/10

(57) ABSTRACT

Systems and methods for distributing analyst's comments on breaking information to interested parties are disclosed. According to various embodiments, the system includes a report module, and a distribution system. The report module is for receiving the analyst comments via a templated user interface and generating a report based on the comments. The distribution system is for distributing the report to interested parties. The user interface may include, at least, a first field for receiving an identification by the analyst of the breaking information, a second field for receiving a description by the analyst of the details of the breaking information, and a third field for receiving an assessment of the breaking information by the analyst.

### BACKGROUND OF THE INVENTION

The present invention is directed generally to authoring and distributing research analysts' initial reactions to breaking information.

In the financial services industry many firms employ analysts who conduct fixed income or equity research and provide reports on various financial issues. Many analysts provide a rating of a company or other business entity with respect to a particular product area. For example, an analyst in the area of equity products may research and rate the perceived present and future value of a company's equity securities. Also, analysts in the area of credit products may research and rate the value of the company's debt securities. For example, a company's securities (equity or debt) that are considered by an analyst as likely to outperform securities in the same industry sector may be rated “overweight.” Similarly, securities of a company that are considered by an analyst as likely to perform at or around the average for its industry sector may be rated “neutral,” and the securities of a company that are considered as likely to perform below securities in its sector may be rated “underweight.” Analysts may also author and distribute commentary about many other kinds of financial instruments including, for example, government bonds, etc.

Breaking financial news or information can often affect an analyst's rating of a particular security or securities in a particular industry sector. For example, a company's announcement of earnings, personnel changes, acquisitions, etc., may affect the analyst's impression of the value of the securities issued by the company. Also, announcements of broader economic factors, such as interest rate changes or employment figures, may impact the value of many securities and/or instruments. Therefore, when breaking financial news occurs, there is often pressure on the analyst from clients and/or traders to give immediate comments on the potential impact. For example, the analyst may be asked for an opinion on how the market will react to the information, and/or how a particular debt security will trade.

It is important for analysts to react to breaking information promptly; however, analysts must take care to comply with various securities rules governing the ways that research and commentary may be distributed. For example, an analyst must take care to distribute commentary to a broad range of investors, not just to a few clients or traders, to avoid selective disclosure. Also, if a trader or client trades on the basis of an analyst's selectively disclosed research, both risk violating trading regulations against trading ahead and front-running research. Financial regulatory bodies across the world have recently begun to tighten their regulation and enforcement concerning selective disclosure, front-running, etc. For example, the Financial Services Authority (FSA) in the United Kingdom has recently eliminated several exceptions to its prohibition on front-running research. Also, in the United States, the Securities and Exchange Commission (SEC) has tightened its enforcement of similar provisions.

Existing techniques for making analysts' commentary generally available are time-consuming and may hinder the analyst from adequately serving clients. For example, it may take as many as six or seven hours for an analyst to prepare a formal report in response to breaking financial news, have the formal report approved for content and disclosure, and make the report publicly available. By this time, the value of the analyst's commentary may have diminished. Some firms have attempted to expedite the process of making commentary generally available by asking the analysts to write short preliminary comments and distributing the comments through the World Wide Web or third party vendors. Even short preliminary comments, however, can require considerable time for preparation, approval and revision because approval personnel must parse and analyze the text of an entire document.

### SUMMARY OF THE INVENTION

In one general aspect, embodiments of the present invention are directed to systems and methods for distributing analyst comments on breaking information to interested parties. The system may comprise, according to various embodiments, a report module, and a distribution system. The report module is for receiving the analyst comments via a templated user interface and generating a report based on the comments. The distribution system is for distributing the report to interested parties. The user interface may include, at least, a first field for receiving an identification by the analyst of the breaking information, a second field for receiving a description by the analyst of the details of the breaking information, and a third field for receiving an assessment of the breaking information by the analyst.

According to various embodiments, the system may also include a compliance module and a supervisory authorization module. The compliance module is for determining whether the report complies with one or more regulatory guidelines, for example. The supervisory authorization module is for submitting the report to a supervisory analyst for approval.

The method may include, for example, the steps of receiving the analyst comments via a templated user interface, generating a report based on the comments, and distributing the report to the interested parties. The templated user interface may include, at least, a first field for receiving an identification by the analyst of the breaking information, a second field for receiving a description by the analyst of the details of the breaking information, and a third field for receiving an assessment of the breaking information by the analyst.

### DESCRIPTION OF THE FIGURES

Embodiments of the present invention will be described by way of example in conjunction with the following Figures, wherein:

FIG. 1 is a diagram of a system for distributing research analysts' initial reactions on breaking information to interested parties according to various embodiments of the present invention;

FIGS. 2-3 are flow charts of methods for distributing research analysts' initial reactions on breaking information to interested parties according to various embodiments of the present invention;

FIGS. 4A-4B are screen shots of user interfaces to a system for distributing research analysts' initial reactions on breaking information to interested parties according to various embodiments of the present invention; and

FIGS. 5-6 are flow charts of methods for distributing research analysts' initial reactions on breaking information to interested parties according to various embodiments of the present invention.

### DESCRIPTION OF THE INVENTION

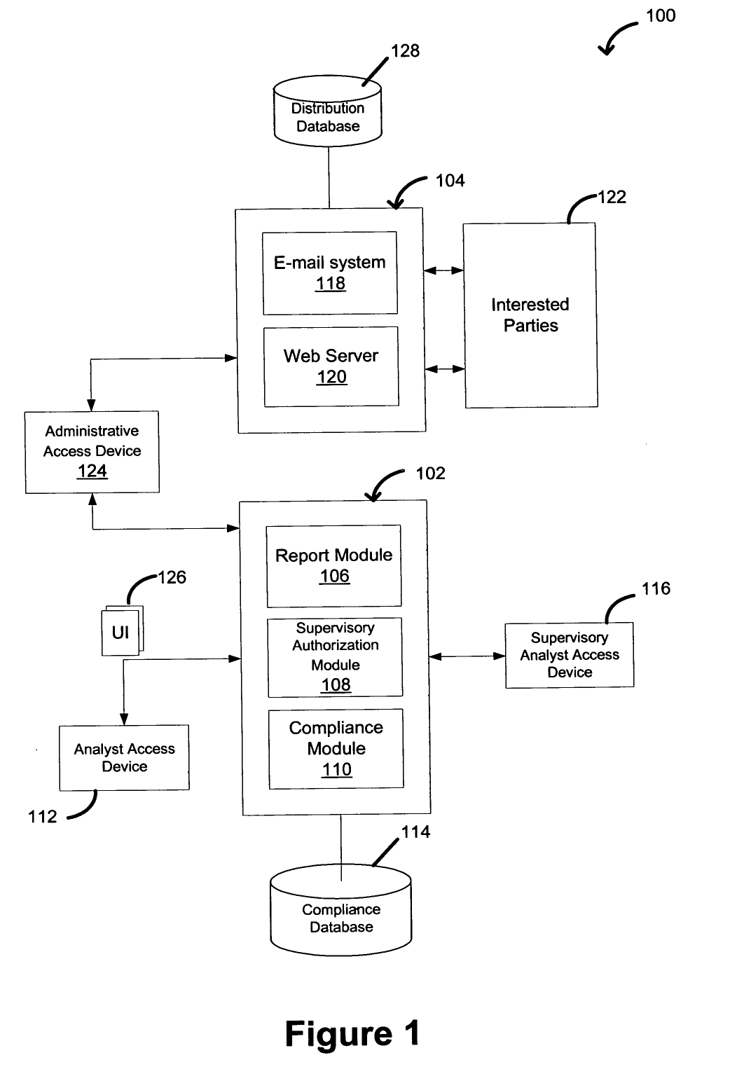

FIG. 1 is a diagram of a system 100 for distributing an analyst's comments on breaking financial news according to various embodiments of the present invention. The system 100 may include a breaking news authoring device 102 and a distribution system 104 configured to distribute the analyst's comments on the breaking information to interested parties 122 according to various embodiments of the present invention. The system 100 may be used by a so-called “sell-side” research firm (such as a brokerage house) to transmit reports on the breaking financial news of the research firm's analysts to interested parties 122. The interested parties 122 may include clients of the research firm, such as large institutional investors, and/or trading and sales personnel associated with the research firm. The various components of the system 100 may be locally and/or remotely located, and may communicate with one another over any communication medium known in the art including, for example, a local area network, the Internet, or a third party vendor.

The breaking news authoring device 102 may generate a report based on the analyst comments regarding breaking financial news, submitted by an analyst from an analyst access device 112, submit the comments for approval to a supervisory analyst (at a supervisory analyst access device 116), and verify that the report complies with industry regulatory rules and standards. The breaking news authoring device 102 may be implemented as one or more centrally and/or remotely located networked computer devices (e.g., servers). The breaking news authoring device 102 may include, as described in more detail below, a report module 106 for generating the report based on the analyst comments on the breaking news, a supervisory authorization module 108 for submitting the report to a supervisory analyst for authorization, and a compliance module 110 for determining whether the report complies with the firm's various compliance standards. The modules 106, 108, and 110 may be implemented as software code executed by a processor (not shown) of the breaking news authoring device 102 using any suitable computer language (e.g., Java, C, C++, Perl) in connection with an object-oriented programming methodology, for example, and/or other conventional programming techniques. In various embodiments, the software code of the modules 106, 108, 110 may be stored as a set of instructions on a computer-readable medium or media such as, for example, a random access memory (RAM), a read-only memory (ROM), a magnetic medium such as a hard drive or a floppy disk, and/or an optical medium, such as a CD-ROM.

Once the report has been authorized and its compliance has been determined, the report is transmitted to interested parties 122 (such as clients of the research firm and/or traders) via the distribution system 104. The report may be transmitted to the interested parties 122 in an e-mail message (including as an attachment in an e-mail message) via an e-mail system 118. Also, the report may be posted on a website, hosted by a web server 120 where the interested parties 122 may access the report.

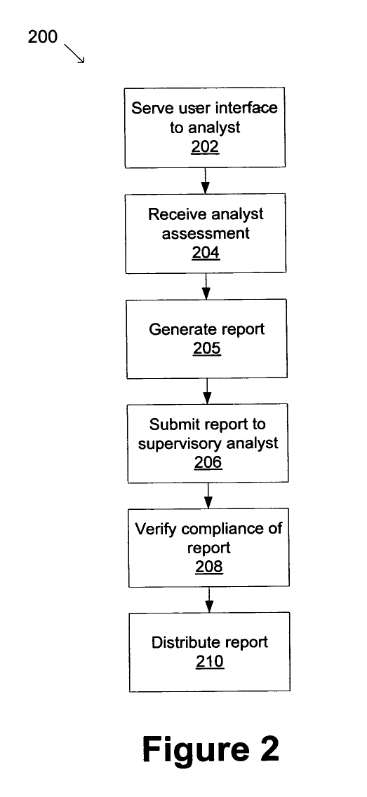

FIG. 2 is flowchart of a process flow 200 for the system 100 according to various embodiments of the present invention. When financial information breaks, an analyst of the research firm, using the analyst access device 112, may request a pre-formatted user interface document 126 from the report module 106 of the breaking news authoring device 102, which in turn may serve the document 126 to the analyst access device 112 at step 202. The analyst access device 112 may be any type of device capable of communicating with the breaking news authoring device 102 locally or remotely including, for example and without limitation, computer devices (such as PC's, laptops, PDA's, pocket PC's, etc.) having browser software (e.g., Microsoft Internet Explorer). At step 204, the analyst may, for example, enter his or her assessment of the news in specific fields of the user interface document 126 as described further below. For example, the analyst may provide an identification, description and assessment of the breaking financial news in corresponding fields of the user interface document 126.

At step 205, upon completion of the document 126 by the analyst, the report module 106 may generate a report containing the analyst's comments. Next, at step 206, the supervisory authorization module 108 may transmit the report for authorization to, for example, a supervisory analyst. The report may be transmitted to the supervisory analyst at the supervisory analyst access device 116, where the supervisory analyst may review and authorize the report. Alternatively, the supervisory analyst may make or request comments, changes, modifications, revisions. etc. to the report, which may then be transmitted to the analyst.

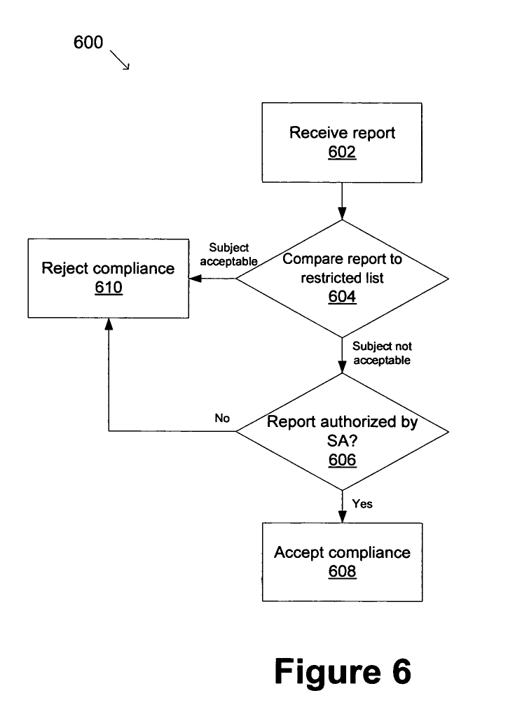

Next, at step 208, the compliance module 110 may verify that transmission of the report to the interested parties 122 is acceptable under compliance standards, rules or regulations of or pertaining to the research firm of the analyst. The compliance module 110 may perform the step based on data stored in a compliance database 114, as described below in connection with FIG. 6. Once satisfaction of the relevant compliance standards may been determined, the report may be distributed to the interested parties 122 at step 210. For example, the report may be e-mailed to interested parties 122 by the e-mail system 118 of the distribution system 104. A distribution database 128 may contain lists of e-mail addresses corresponding to parties interested in a particular analyst's comments to whom the analyst reports are transmitted. Also, the report may be posted on a web site hosted by a web server 120.

The supervisory access device 116, like the analyst access device 112, may be any type of device capable of communicating with the breaking news authoring device 102 locally or remotely including, for example and without limitation, computer devices (such as PC's, laptops, PDA's, pocket PC's, etc.) having browser software (e.g., Microsoft Internet Explorer).

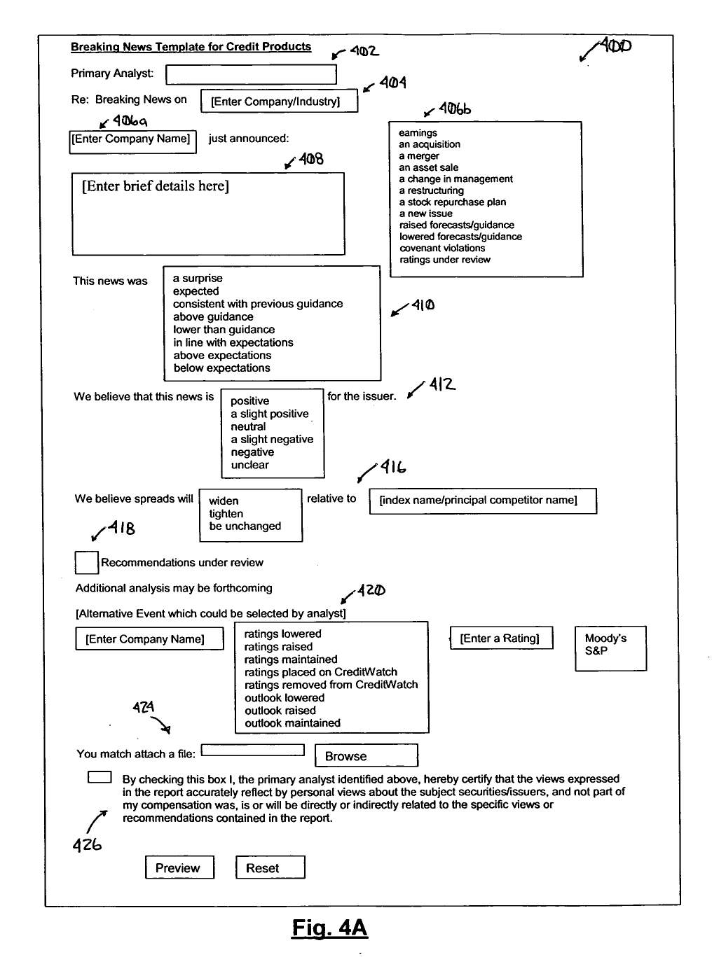

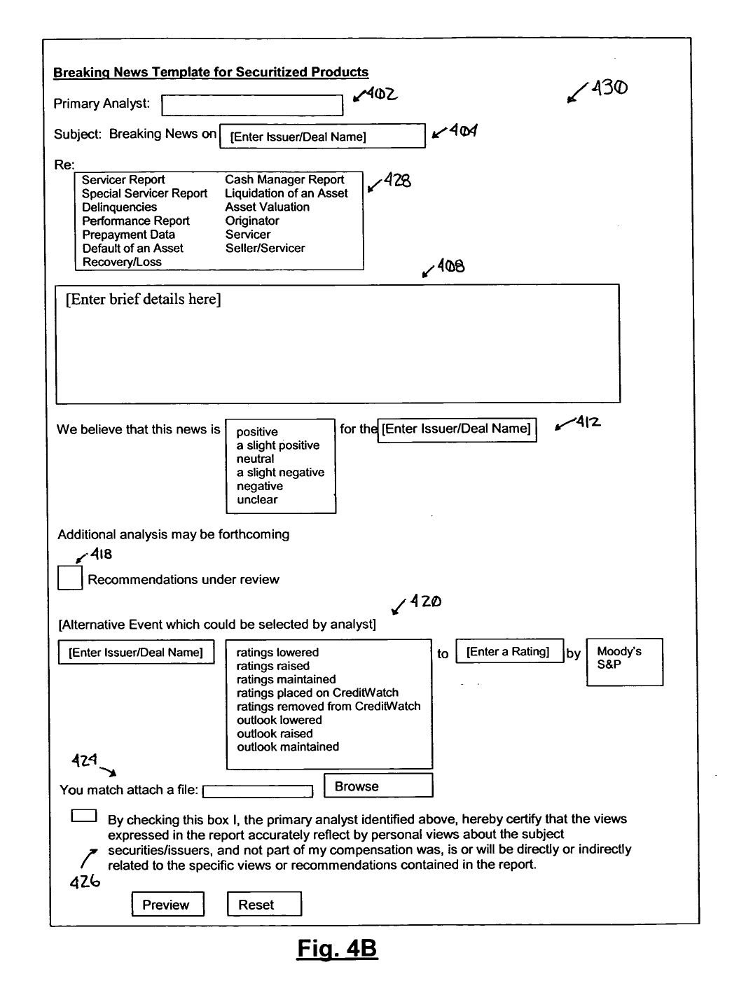

According to various embodiments, the report module 106 may provide an analyst with one or more user interface documents (UIs) in order that the analyst may enter the assessment of the breaking news in the document. Examples of UI documents that may be presented to users of the system 100 according to various aspects of the present invention are illustrated in FIGS. 4A-4B. In general, UI documents may allow the user to expeditiously enter the assessment in a pre-formatted way that not only increases the alacrity with which the analyst can enter the assessment, but also the review of the resulting report.

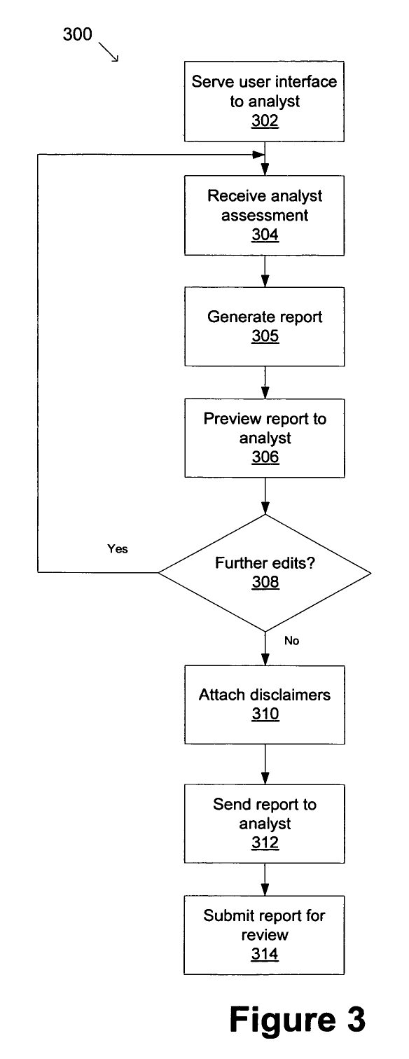

FIG. 3 is a flowchart of the process flow 300 through the report module 106 of the breaking news authoring device 102 according to various embodiments. At step 302, the report module 106 may serve the user interface document 126 to the analyst, for example, via the analyst access device 112. The user interface document 126 may be templated to request discrete information from the analyst, for example, by asking the analyst to choose entries from a series of predetermined lists. In various embodiments, one user interface document may be used for different products. Alternatively, a number of different user interface documents may be used that are specific to a particular product area. An analyst who provides comments on multiple kinds of products and may therefore be provided different templated user interface documents 126 for different product areas.

FIG. 4A shows an example of a particular user interface document 400 that may be used by the analyst to provide comments on credit products according to various embodiments. Many of the fields 402-426 of the user interface document 400 include drop-down menus, allowing the analyst to select phrases, companies, etc. from a predetermined list. At field 402, the analyst may enter his or her name. At field 404, the analyst may provide a brief description of the subject of the breaking information. Fields 406a-b may also allow the analyst to enter a pre-formatted description of the breaking information. If other commentary is needed regarding the description of the breaking information, the analyst may type the commentary into the free-form text field 408. Free-form text, however, is preferably minimized to expedite the review and approval process.

Various fields request the analyst's assessments or opinions about the breaking information and its effects. At field 410, the analyst may indicate whether the breaking information was expected or unexpected, for example. Also, the analyst may state whether the news is positive or negative for the given product at field 412. At field 416, the analyst may indicate his belief regarding spreads. At field 418 the analyst may indicate whether the analyst will provide further commentary such as, for example, a full report at a later time. If a rating body, such as, for example, Moody's or S&P, has changed the rating of the company's product, the analyst may note that in field 420.

According to various embodiments, the analyst may attach a file in the user interface document 400 at field 424. The file may be, for example, a copy of the press release announcing the breaking information or an earnings calendar. The file may also be a non-publicly available document, however, this may slow down the authorization process as described in more detail below. According to various embodiments, the user interface document 400 may also include a Reg. AC disclaimer at field 426, which may be affirmed by checking the box.

FIG. 4B is an example of another particular user interface document 430 provided to analysts who give commentary on securitized products according to various embodiments. In many respects, the user interface document 430 may be similar to the user interface document 400 for credit products (see FIG. 4A), however, there may be some differences. For example, the pre-determined selections in several of the fields 402-426 may have different values. Also, for example, with the user interface document 430 for securitized products, an analyst may select the subject of the breaking information from a pre-determined list, for example, in a drop-down menu 428. It can be appreciated that different user interface documents may be developed for different product areas, or that one user interface document could be used for multiple products.

Referring back to FIG. 3, at step 304 the report module 106 may receive the analyst's assessment of the breaking information entered through the user interface documents as described above. In various embodiments, the user interface document may fail to receive further information, or time-out if the analyst does not finish entering comments within a given time period, for example, twenty minutes. At step 305, the report module 106 may generate a report including the analyst's assessments. The report may include, for example, the analyst's comments with respect to each field of the user interface document 126. Next, at step 306, the report module 106 may show the analyst a preview of the report. The report module 106 may prompt the analyst for further edits to the report at step 308. If the analyst has further edits, the report module 106 may receive the edits at step 304. If the analyst has no further edits, the report module 106 may attach further disclaimers to the report at step 310.

The disclaimers may be required to comply with regulatory rules, which often require that analyst comments and analysis include appropriate disclaimers. For example, if the analyst owns the particular security that is the subject of the comments, or if the analyst's firm owns more than a certain percentage of the total amount of the security, or provides investment banking advice to the issuer of the security, the report may be required to note this in a disclaimer. In various embodiments, the process of attaching disclaimers may be automated, for example, by comparing the subject of the analyst comments to a list of issuers/companies for whom disclaimers are required and attaching the appropriate disclaimers. Disclaimers may also be attached manually, for example, by visiting a web-site, or other content provider, containing a listing of possible disclaimers and choosing those that should be attached. The report may be e-mailed to the analyst at step 312 and submitted to a review process at step 314. In some embodiments, disclaimers may be attached concurrent to the review process. After approval, the distribution system 104 may forward the e-mail message containing the report to interested parties 122.

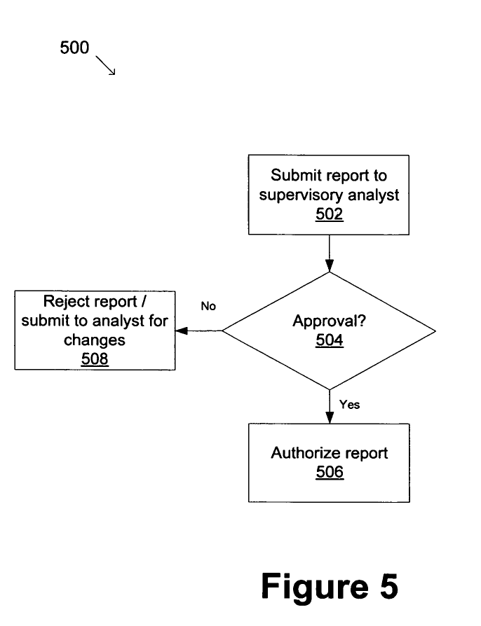

FIG. 5 is a flowchart of the process flow 500 through the supervisory authorization module 108 according to various embodiments. At step 502, the supervisory authorization module 108 may transmit the report to one or more supervisory analysts at supervisory analyst access device 116. The supervisory analyst access device 116 may alert a supervisory analyst when a report arrives by, for example, sounding an alarm. The supervisory authorization module 108 may send a particular report to more than one supervisory analyst for review. The first supervisory analyst to become available may review the report. Once a supervisory analyst has begun review of a report, the supervisory authorization module 108 may prevent other supervisory analysts from beginning to review the report, for example, by preventing further access to the report.

At step 504, the supervisory analyst may determine whether the report is acceptable. It will be appreciated that fields in the user interface document 126 that include a drop-down menu and therefore a limited amount of possible entries may be checked quickly. A supervisory analyst may only need to check those fields for consistency with the rest of the comments. On the other hand, fields that allow free-form text, such as field 408, and/or non-public attached files may require more extensive review from the supervisory analyst, such as, for example, a review for outrageous or inflammatory language. Accordingly, analysts may be trained to minimize their free-form comments in these fields to reduce review time. If the supervisory analyst determines that the report is acceptable, the comments may be authorized at step 506. If the report is not acceptable it may be rejected at step 508. According to various embodiments, a rejected report may be returned to the analyst for editing via the analyst access device 112. The process may then be repeated if necessary.

FIG. 6 is a flowchart of the process flow 600 through the compliance module 110 according to various embodiments. The compliance module 110 may determine whether the report complies with, for example, firm policies such as policies relating to compliance standards, rules or regulations of or pertaining to the research firm of the analyst. At step 602, the compliance module 110 may receive the report. The compliance module 110 may receive the report at the same time as the supervisory authorization module 108. In some embodiments, however, the compliance module 110 may not be allowed to accept the report until it is first approved by the supervisory authorization module 108.

At step 604, the compliance module 110 may, for example, compare the subject of the report to a restricted list of subjects that the firm may not comment on under applicable regulations. For example, the restricted list may be a listing of companies that have retained the firm to provide certain services such as, for example, investment banking advice. The list of restricted entries may be stored in the compliance database 128. By comparing, for example, the subject fields 404, 406a, 428, etc., with the restricted list, the compliance module 110 may determine whether the comments satisfy applicable compliance standards.

If the subject of the report is contained in the restricted list in the compliance database 128, then the report may be rejected at step 610. If the subject of the report is not restricted, the process may advance to step 608, where the compliance module 110 may determine whether the report has previously been authorized by a supervisory analyst, for example, though the supervisory authorization module 108. If a supervisory analyst has approved the report, the compliance module 110 may accept the report at step 608.

After the report has been fully authorized it may be distributed to the interested parties 122 automatically by the distribution system 104. The e-mail system 118 of the distribution system 104 may forward the report to all of the addresses on a firm and/or analyst bulk mail list. In various embodiments, the firm may have multiple bulk mail lists categorized by financial product, company, etc. The bulk mail lists may contain both standard Internet e-mail addresses, and addresses in a third party financial news messenger service, such as Bloomberg. Particular reports may be sent to one or more bulk mail lists containing the addresses of parties who may be interested in the reports.

In addition, or in the alternative, the web server 120 of the distribution tool may publish the report, for example, on a website accessible through the World Wide Web. Reports may be published, for example, on a website administered by the firm employing the analyst. Also, the report may be distributed manually.

Referring back to FIG. 1, in various embodiments, a representative of the research firm (an administrative user) may access the breaking news authoring device 102 and/or distribution system 104 through one or more administrative access devices 124. Examples of suitable administrative access devices 116 may include, for example, personal computers running browser applications and having various input/output devices (e.g., keyboard, mouse, touch screen, etc.) for processing user data. In various embodiments, the administrative user may use the administrative access device 124 to track various statistics about a particular report, including the time that it takes for each report to be approved, the size and amount of free-form text in each comment, etc.

Embodiments of the present invention may provide many advantages over the prior art. For example, various features of the present invention allow an analyst to, in just a few minutes, compose, gain approval of, and distribute comments on a breaking financial news event. Thus, the analyst may be free to discuss the breaking information with clients and traders more quickly without running afoul of applicable regulations. The speed of the system 100 may be the result of one or more of a number of features including, for example, constraining most analyst comments to selections from pre-populated drop-down menus, and streamlining compliance checking.

While several embodiments of the invention have been described, it should be apparent that various modifications, alterations and adaptations to those embodiments may occur to persons skilled in the art. For example, various distribution or review methods may be added or subtracted. Also, various steps of processes described herein may be performed in different orders. It is therefore intended to cover all such modifications, alterations and adaptations without departing from the scope and spirit of the present invention as defined by the appended claims.

1. A system for distributing analyst comments on breaking information to interested parties, the system comprising:
a report module for receiving the analyst comments via a templated user interface and generating a report based on the comments, wherein the user interface includes at least:
a first field for receiving an identification by the analyst of the breaking information;
a second field for receiving a description by the analyst of the details of the breaking information;
a third field for receiving an assessment of the breaking information by the analyst; and
a distribution system for distributing the report to the interested parties.

2. The system of claim 1, further comprising a compliance module for determining whether the report complies with a guideline.

3. The system of claim 1, wherein the third field has an associated drop-down window including a plurality of pre-selected assessments to be selected by the analyst.

4. The system of claim 1, wherein the user interface further includes a fourth field in which the analyst can enter free-form text regarding the breaking information.

5. The system of claim 2, further comprising a supervisory authorization module for submitting the report to a supervisory analyst for approval.

6. The system of claim 5, wherein the supervisory authorization module operates concurrently with the compliance module.

7. The system of claim 1, wherein the distribution system is for sending the report to an interested party at an e-mail address.

8. The system of claim 7, wherein the e-mail address is an address within a financial news messenger service.

9. The systems of claims 1 or 7, wherein the distribution system is for posting the report on a web server accessible by the World Wide Web.

10. The system of claim 1, wherein the report module is further for providing to the analyst a user interface document specific to the product to be analyzed by the analyst.

11. The system of claim 10, wherein the product to be analyzed is a securitized product.

12. The system of claim 10, wherein the product to be analyzed is a credit product.

13. The system of claim 10, wherein the product to be analyzed is an interest rate product.

14. The system of claim 4, wherein the report includes at least one attached file.

15. The system of claim 14, wherein the report includes at least one disclaimer.

16. The system of claim 15, wherein the report module is also for selecting and attaching at least one disclaimer to the report.

17. The system of claim 2, wherein the compliance module is for determining whether the report complies with a guideline by comparing a subject of the analyst comments to a restricted list of subjects.

18. A method for distributing analyst comments on breaking information to interested parties, the method comprising:
receiving the analyst comments via a templated user interface, wherein the user interface includes at least:
a first field for receiving an identification by the analyst of the breaking information;
a second field for receiving a description by the analyst of the details of the breaking information;
a third field for receiving an assessment of the breaking information by the analyst;
generating a report based on the comments; and
distributing the report to the interested parties.

19. The system of claim 18, wherein the user interface further includes a fourth field in which the analyst can enter free-form text regarding the breaking information.

20. The method of claim 18, further comprising determining whether the report complies with a guideline.

21. The method of claim 18, wherein third field has an associated drop-down window including a plurality of pre-selected assessments to be selected by the analyst.

22. The method of claim 20, further comprising submitting the report to a supervisory analyst for approval.

23. The method of claim 22, wherein the determining step and the submitting step occur concurrently.

24. The method of claim 18, wherein distributing the report includes sending the report to an interested party via e-mail.

25. The methods of claims 18 or 24, wherein distributing the report includes posting the report on a web server accessible by the World Wide Web.

26. The method of claim 18, wherein the user interface is specific to the product to be analyzed by the analyst.

27. The method of claim 26, wherein the product to be analyzed is a securitized product.

28. The method of claim 26, wherein the product to be analyzed is a credit product.

29. The method of claim 26, wherein the product to be analyzed is an interest rate product.

30. The method of claim 19, wherein the report includes at least one attached file.

31. The method of claim 30, wherein the report includes at least one disclaimer.

32. The method of claim 31, further comprising automatically selecting and attaching at least one disclaimer to the report.

33. The method of claim 20, wherein determining whether the report complies with a guideline includes comparing a subject of the analyst comments to a restricted list of subjects.

34. A computer readable medium containing instructions that when executed by a processor cause the processor to perform a method for distributing analyst comments on breaking information to interested parties, the method comprising:
receiving the analyst comments via a templated user interface, wherein the user interface includes at least:
a first field for receiving an identification by the analyst of the breaking information;
a second field for receiving a description by the analyst of the details of the breaking information;
a third field for receiving an assessment of the breaking information by the analyst;
generating a report based on the comments; and
distributing the report to the interested parties.
